(19) United States
(12) Patent Application Publication
(10) Pub. No.: US 2006/0093144 A1
(43) Pub. Date: May 4, 2006

(54) Communications method for at least two system components of a motor vehicle

(76) Inventor: Wolfgang Reinelt, Stuttgart (DE)

Correspondence Address: KENYON & KENYON LLP, ONE BROADWAY, NEW YORK, NY, 10004, US

(21) Appl. No.: 11/193,256

(22) Filed: Jul. 29, 2005

(30) Foreign Application Priority Data
Jul. 29, 2004 (DE) 10 2004 036 810.4

(51) Int. Cl. G06F 17/30; H04K 1/00

(52) U.S. Cl. 380/258; 707/1

(57) ABSTRACT

In a communications system for at least two system components over a network connection, e.g., a CAN bus system of a motor vehicle, system components have ready in each case a prespecified, fixed number of test codes known only to them. Based on a time-variable signal which is accessible to both system components, at the start of the vehicle, one of the test codes is selected by both system components via an assignment function present as a hash function, and with this test code, the payload data that are to be transmitted are coded. The assignment function and the test codes are stored in data areas of system components that are secured against unauthorized access.

### CROSS-REFERENCE TO RELATED APPLICATIONS

The present application claims priority to Application No. 10 2004 036 810.4, filed in the Federal Republic of Germany on Jul. 29, 2004, which is expressly incorporated herein in its entirety by reference thereto.

### FIELD OF THE INVENTION

The present invention relates to a communications method for at least two system components of a motor vehicle.

### BACKGROUND INFORMATION

System components in motor vehicles, especially control units, sometimes exchange data relevant to safety. This applies above all to vehicle system components (e.g., steering systems, etc.), which make possible for superordinated vehicle system components (e.g., ESP, etc.) direct access channels to the actuator system (active steering systems, leveling systems, brakes).

Conventional safety norms demand adequate safety and reliability of the transmission medium, which in general is the CAN bus system of the vehicle. In this context, the so-called safety integrity level definitions (SIL according to IEC 61508) may play an important role. From conventional norms come two basic requirements (F1, F2):
F1 the point in time of the sending of the signal at the sender's end has to be verifiable by the receiver.
F2—the probability of data corruption on the transmission medium must not exceed a required magnitude.

A third requirement (F3) with regard to the authenticity of the sender, that is, the superordinated vehicle system is put on the communication with the above-mentioned vehicle systems or vehicle system components, that are critical to safety, which permit direct access possibilities to the actuator system of the motor vehicle:
F3 the sender of the message or requirement has to be able to be identified.

This requirement comes about due to the fact that retrofitted third systems (so-called tuning sets) are easily able to identify the requirements or the instructions of the superordinated vehicle systems on the transmission medium (CAN bus), and are able to replace them by their own, changed requirements. In this context, it may be problematic that such requirements, under certain circumstances, are based on faulty safety concepts, and bring with them the danger of false activation of the actuator system. In addition, the measures for securing the communications between the superordinated control units and the actuator control units in the motor vehicle may become partially known, whether by illegal receipt of underlying control unit software (bit error detection, signal conditioning of the so-called standard core of the manufacturer), by reengineering measures (reading out of fixed memories, such as EEPROM, current requirement of the control unit) or by so-called side channel attacks.

Whereas the above-named requirement F1 may already be sufficiently satisfied by time stamps and counters in the CAN bus messages, requirements F2 and F3 may be satisfied only inadequately, or not at all, by conventional systems or the usual CAN bus protocol having a CRC-15 checksum character (bit error detection by cyclic redundancy check)

In cryptography, residual error probabilities may be derived for the occurrence of bit errors in the transmission for the corresponding CRC checksums.

Furthermore, certain conventional methods verify the authenticity of senders and receivers. Besides usual applications, e.g., WLAN or Bluetooth, this is also conventional for embedded systems, for example, from “Wollfinger, Guajardo and Paar, Cryptography in Embedded Systems: An Overview, Proceedings of the Embedded World 2003 Exhibition and Conference, pp. 735 to 744, Design & Electronic Systems, Nuremberg, Germany, February 18 to 20, 2003.” However, such design approaches may be able to be implemented only with difficulty, because of large network bandwidths required and great computing intensities in the automotive field. Design approach attempts for so-called sensor or ad hoc networks, which may require a low computing performance, may also require CRC checksums that are too long for the vehicle CAN bus systems.

### SUMMARY

An example embodiment of the present invention may provide a communications method that may make possible communications that are secure and sparing of resources.

By these measures, and in a simple manner, communications between system components of a motor vehicle may be created that may be reliable and secure from eavesdropping or monitoring. By a combination of agreed test codes with a transmission sequence specified by a hash function, a secure authentication of the sender may be made possible. Consequently, for example, requirements of intruders may be ignored if a missing authentication is detected. Consequently, misactivations brought on by intruders may be largely avoided. The communications method may not be computation-intensive, and thus may also save on resources.

The system components may have access-protected data regions, in which the hash function and the test codes linked to the domain of the hash-function are stored.

Thereby the spying into or reengineering of the system ay be made more difficult.

It may be provided that the initialization phase takes place at final test or end of assembly line testing of the system components in the motor vehicle.

In this context, the first superordinated system component transmits start code aₙ to the second system component. The testing may be undertaken as to whether start code aₙ fit and the hash function fit with each other. A suitable test may be, for example, the notification of aₙ₋₁ by the first system component and the corresponding test in the second system component as to whether aₙ=h(aₙ₋₁).

By a pair-wise exchange of start code an, the system components may be used interchangeably as sender and receiver.

Several different hash functions and/or natural numbers n may be used according to a predefined scheme or one that is communicated in a coded manner.

Thereby, attacks by intruders may be further minimized.

It may be provided that the sending of the new start code aₙ takes place in code.

As a time-variable signal, for example, the kilometer reading of the vehicle or the clock time at the start of the vehicle (terminal 15) may be used.

In order further to increase the reliability of the communication of two system components of a motor vehicle via a CAN bus system, the payload data of a message packet may have an additional CRC checksum.

An increase in the region available for the payload data, or the reliability, may be achieved by transmitting the message on at least two physically separated media, e.g., CAN bus lines and subsequent comparison at the receiver end.

According to an example embodiment of the present invention, a communication method for at least two system components of a motor vehicle via a network connection, each of the first system component and the second system component having available, via at least one hash function, at least one natural number n and a plurality of test codes, includes: (a) computing, by a first one of the first system component and the second system component, a hash chain according to the relationship aᵢ₊₁=h(aᵢ) having a length equal to the natural number n and based on a random number representing a₀; (b) linking, by the first one of the first system component and the second system component, the test codes to a respective member of the hash chain; (c) sending, by the first one of the first system component and the second system component, a last member of the hash chain aₙ as a start code; (d) for each subsequent authentication after the steps (a), (b) and (c), transmitting, by the first one of the first system component and the second system component, one of (a) a payload datum together with the test code linked to a current member of the hash chain aᵢ, uncoded, and (b) the payload datum together with the test code linked to the current member of the hash chain aᵢ, coded, to a second one of the first system component and the second system component; (e) after the step (d), and for each subsequent authentication after the steps (a), (b) and (c), transmitting, by the first one of the first system component and the second system component, the current member of the hash chain aᵢ to the second one of the first system component and the second system component; (f) after step (e), and for each subsequent authentication after the steps (a), (b) and (c), checking, by the second one of the first system component and the second system component, the current element of the hash chain aᵢ transmitted by the first one of the first system component and the second system component with the hash chain, and, if the current element of the hash chain aᵢ transmitted by the first one of the first system component and the second system component agrees with the hash chain aᵢ₊₁=h(aᵢ), at least one of (a) accepting and (b) decoding, by the second one of the first system component and the second system component, the payload datum; (g) at each renewed vehicle start, decrementing a counter by 1 to select a new member of the hash chain aᵢ₋₁; and (h) restarting the method at step (a) when the counter is decremented to 0.

The network connection may include a CAN bus system of the motor vehicle.

The first system component and the second system component may include access-protected data regions, and the hash function and the test codes may be stored in the access-protected data regions.

The steps (a), (b) and (c) may be preformed as a final test of the first system component and the second system component.

The first system component and the second system component may each be arranged as senders and receivers, and the method may include a pair-wise exchange of respective start codes between the first system component and the second system component.

The at least one hash function may include a plurality of different hash functions used according to one of (a) a predefined scheme and (b) a scheme communicated in coded form.

The at least one natural number may include a plurality of different natural numbers used according to one of (a) a predefined scheme and (b) a scheme communicated in coded form.

The start code may be sent in the sending step in a coded manner.

The first system component may include an ESP control unit, and the second system component may include a steering system control unit.

According to an example embodiment of the present invention, a communications method for two system components of a motor vehicle via a network connection, each system component including a prespecified, fixed number of test codes known only to the system components, includes: selecting, based on a time-variable signal accessible to both system components at a start of the motor vehicle, one of the test codes by both system components; coding payload data to be transmitted with the selected one of the test codes; and storing the assignment function and the test codes in data areas of the system components that are secured against unauthorized access.

The network connection may include a CAN bus of the motor vehicle.

The assignment function may include a hash function.

According to an example embodiment of the present invention, a communications method for two system components of a motor vehicle via a CAN bus system of the motor vehicle, includes: providing payload data of a CAN bus message packet with an additional CRC checksum different from a standard CRC checksum of the CAN bus system.

The method may include: sending messages on at least two physically separate media; and subsequently comparing the messages at a receiver.

The at least two physically separate media may include CAN bus lines.

Example embodiments of the present invention are described below with reference to the appended Figures.

### BRIEF DESCRIPTION OF THE DRAWING

FIG. 1 is a schematic view of a network topology for implementing a communication method according to an example embodiment of the present invention.

### DETAILED DESCRIPTION

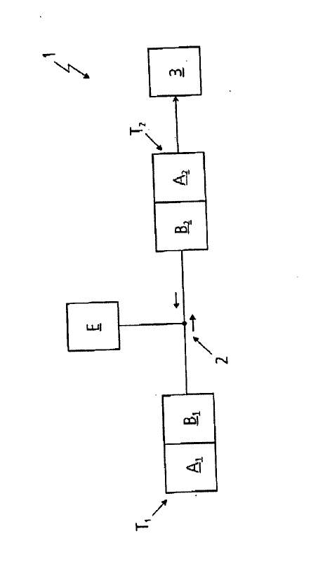

FIG. 1 illustrates a network topology 1 between superordinated first system component T₁, that may be arranged as an ESP control unit, and a subordinated second system component T₂, that may be arranged as a steering system control unit, of a motor vehicle, which may make possible a direct access to an actuator 3, arranged, e.g., as a steering system. The network connection takes place over a CAN bus system 2. The steering system control unit T₂ may be a part of an active steering system, as is described, for example, in German Published Patent Application No. 196 01 826.

The specification of the CAN bus protocol is known to an intruder E, that is, it knows which signals are at which place, and how they are coded. Furthermore, intruder E knows parts B₁ and B₂ of system components T₁, T₂. Parts B₁ and B₂ communicate directly with CAN bus system 2 and have, among other things, the CRC coding mechanisms for the bit error detection, and for the signal conditioning.

With a communications method hereof, it may be prevented that intruder E, on account of its knowledge, places a security-relevant signal or a security-relevant message of first system component T₁ to second system component T₂ at the appropriate place in CAN bus 2, protects it appropriately, and, e.g., overwrites the signal of first system component T₁, therewith, and that this falsified signal is then also accepted by second system component T₂.

For this purpose, two communications methods may be provided.

1. System components T₁, T₂ have ready in each case a prespecified, fixed number of test codes known only to them. Based on a time-variable signal which is accessible to both system components T₁, T₂, at the start of the vehicle, one of the test codes is selected by both system components T₁, T₂ via an assignment function that may be arranged as a hash function, and with this test code, the payload data that are to be transmitted are coded. The assignment function and the test codes are stored or filed in data areas A₁, A₂ of system components T₁, T₂ that are secured against unauthorized access.

What may be a problem, in this context, is that intruder E may have to gain possession of the assignment function and the test code only once in order to be able to circumvent the authentication permanently.

2. First system component T₁ and second system component T₂ jointly have available to them a hash function h, a natural number n and a plurality of test codes. First system component T₁ computes a hash chain aᵢ₊=h(aᵢ) of length n, using a random number a₀, links the test codes to the respective aᵢ and discloses the last element aₙ of the hash chain as the start code or public key. At each subsequent authentication, for 0<I<n:
first system component T₁ transmits a payload datum, uncoded, with the test code linked to aᵢ, or the payload datum, coded, with the test code linked to the current element aᵢ to second system component T₂, whereafter:
first system component T₁ transmits element aᵢ to second system component T₂, whereafter:
second system component T₂, using the hash chain aᵢ₊₁=h(aᵢ), checks element aᵢ transmitted by first system component T₁, and, if there is agreement, accepts and/or decodes the transmitted payload datum.

At each fresh vehicle start, i is decremented by 1, and thus a new element aᵢ₋₁ is selected, at i=0, at the next vehicle start, again, as described above, a new start code aₙ is generated and disclosed by first system component T₁.

Any desired method may be used for coding.

Hash function h and the test codes are stored in data areas A₁, A₂ of system components T₁, T₂, that are secured against unauthorized access.

The initialization phase takes place at end-of-the-line testing of system components T₁, T₂ in the motor vehicle. In this context, first superordinated system component T₁ transmits the start code or public code aₙ to second system component T₂. Testing may be undertaken as to whether start code aₙ and hash function h fit with each other. A suitable test may be, for example, the communication of aₙ₋₁ and the corresponding test in second system component T₂ as to whether aₙ=h(aₙ₋₁).

By a pair-wise exchange of start code aₙ, system components T₁, T₂ may be used interchangeably as sender and receiver.

Secure hash functions, such as SHA-1, have a length of 160 bits, which exceed a CAN bus message length. At a system start, since the key may be transmitted instead of a payload message, 34 bits are possible. In order to minimize the probability of an attack, several hash functions h and/or natural numbers n may be able to be used according to a predefined scheme or one that is communicated in a coded manner.

Sending new start code aₙ may be done in a coded manner. However, sending it uncoded is also possible.

In order to minimize the probabilities of residual errors in the transmission, the following communications method is provided for the CAN bus system, so as to satisfy requirement F2.

The payload data of a CAN message packet have an additional CRC checksum for this. In addition, a time stamp may also be provided.

Additional reliability may be achieved by sending the messages over at least three physically separated media, e.g., CAN bus lines and subsequent comparison at receiver T₂.

Depending on the signal integrity level (SIL) according to IEC 61508 “Functional Safety of E/E/PES Systems, IEC, Geneva, Switzerland, Edition 1[1].0 b. Dec. 1, 1998” of the signal to be transmitted, a 20 to 26 bit CRC checksum may be sufficient for a secure transmission. This may have to be different from the CRC-15 bit error detection of the standard CAN transmission protocol.

In a transmission via only one CAN bus line, an SIL3 message may include the following:

26 bit CRC checksum;

4 bit time stamp;

34 bit payload datum;

CRC-15 in standard CAN transmission protocol.

If an SIL3 signal is transmitted over two physically separate bus lines, an SIL2 protection on both lines and a corresponding comparison may be sufficient. If both media are standard CAN bus lines having CRC-15 protection, an additional protection having a CRC-23 protection per bus line may be sufficient. Consequently, the payload area of the packets may only be diminished by 23 bits. If three bus lines are used, and all three are executed, as described above, according to SIL2, the availability may be increased via an appropriate two-of-three decision by the receiver.

REFERENCE NUMERALS

| | |
|---|---|
| 1 | Network topology |
| 2 | CAN bus system |
| 3 | Actuator or steering system |
| T₁, T₂ | System components |
| A₁, A₂ | Secure areas |
| B₁, B₂ | Communications parts |
| E | Intruder |

What is claimed is:

1. A communication method for at least two system components of a motor vehicle via a network connection, each of the first system component and the second system component having available, via at least one hash function, at least one natural number n and a plurality of test codes, comprising:
(a) computing, by a first one of the first system component and the second system component, a hash chain according to the relationship aᵢ₊₁=h(aᵢ) having a length equal to the natural number n and based on a random number representing a₀;
(b) linking, by the first one of the first system component and the second system component, the test codes to a respective member of the hash chain;
(c) sending, by the first one of the first system component and the second system component, a last member of the hash chain aₙ as a start code;
(d) for each subsequent authentication after the steps (a), (b) and (c), transmitting, by the first one of the first system component and the second system component, one of (a) a payload datum together with the test code linked to a current member of the hash chain aᵢ, uncoded, and (b) the payload datum together with the test code linked to the current member of the hash chain aᵢ, coded, to a second one of the first system component and the second system component;
(e) after the step (d), and for each subsequent authentication after the steps (a), (b) and (c), transmitting, by the first one of the first system component and the second system component, the current member of the hash chain aᵢ to the second one of the first system component and the second system component;
(f) after step (e), and for each subsequent authentication after the steps (a), (b) and (c), checking, by the second one of the first system component and the second system component, the current element of the hash chain aᵢ transmitted by the first one of the first system component and the second system component with the hash chain, and, if the current element of the hash chain aᵢ transmitted by the first one of the first system component and the second system component agrees with the hash chain aᵢ₊₁=h(aᵢ), at least one of (a) accepting and (b) decoding, by the second one of the first system component and the second system component, the payload datum;
(g) at each renewed vehicle start, decrementing a counter by 1 to select a new member of the hash chain aᵢ₋₁; and
(h) restarting the method at step (a) when the counter is decremented to 0.

2. The method according to claim 1, wherein the network connection includes a CAN bus system of the motor vehicle.

3. The method according to claim 1, wherein the first system component and the second system component include access-protected data regions, the hash function and the test codes stored in the access-protected data regions.

4. The method according to claim 1, wherein the steps (a), (b) and (c) are preformed as a final test of the first system component and the second system component.

5. The method according to claim 1, wherein the first system component and the second system component are each arranged as senders and receivers, the method further comprising a pair-wise exchange of respective start codes between the first system component and the second system component.

6. The method according to claim 1, wherein the at least one hash function includes a plurality of different hash functions used according to one of (a) a predefined scheme and (b) a scheme communicated in coded form.

7. The method according to claim 1, wherein the at least one natural number includes a plurality of different natural numbers used according to one of (a) a predefined scheme and (b) a scheme communicated in coded form.

8. The method according to claim 1, wherein the start code is sent in the sending step in a coded manner.

9. The method according to claim 1, wherein the first system component includes an ESP control unit and the second system component includes a steering system control unit.

10. A communications method for two system components of a motor vehicle via a network connection, each system component including a prespecified, fixed number of test codes known only to the system components, comprising:
selecting, based on a time-variable signal accessible to both system components at a start of the motor vehicle, one of the test codes by both system components;
coding payload data to be transmitted with the selected one of the test codes; and
storing the assignment function and the test codes in data areas of the system components that are secured against unauthorized access.

11. The method according to claim 10, wherein the network connection includes a CAN bus of the motor vehicle.

12. The method according to claim 10, wherein the assignment function includes a hash function.

13. A communications method for two system components of a motor vehicle via a CAN bus system of the motor vehicle, comprising:
providing payload data of a CAN bus message packet with an additional CRC checksum different from a standard CRC checksum of the CAN bus system.

14. The method according to claim 13, further comprising:
sending messages on at least two physically separate media; and
subsequently comparing the messages at a receiver.

15. The method according to claim 14, wherein the at least two physically separate media include CAN bus lines.
